(19) United States
(12) Patent Application Publication
(10) Pub. No.: US 2022/0026249 A1
(43) Pub. Date: Jan. 27, 2022

(54) DEVICE AND METHOD FOR DETECTING A BLOCKAGE POSITION IN A PIPELINE

(71) Applicants: Guo-Hao Wang, Jimo City (CN); Bing Wang, Nanjing City (CN); Kuo-Hsin Chang, Chiayi County (TW); Chung-Ping Lai, Hsinchu County (TW)

(72) Inventors: Guo-Hao Wang, Jimo City (CN); Bing Wang, Nanjing City (CN); Kuo-Hsin Chang, Chiayi County (TW); Chung-Ping Lai, Hsinchu County (TW)

(73) Assignee: GRAPHENE SECURITY LIMITED, Manchester (GB)

(21) Appl. No.: 16/936,422

(22) Filed: Jul. 23, 2020

(51) Int. Cl. G01F 1/56; F17D 3/01; G08C 17/02

(52) U.S. Cl. CPC G01F 1/56; G08C 17/02; F17D 3/01

(57) ABSTRACT

A device and a method for detecting a blockage position in a pipeline by RFID technology is disclosed. An RFID tag is disposed in a pipe of a pipeline first, the RFID tag is read with a predetermined single or double frequencies, and finally whether the position of the pipe at which the RFID tag is located is blocked or not can be judged by the difference between the echo signals sent from the RFID tag. By the RFID technology, a contactless and non-destructive approach of detecting a blockage in a pipeline is implemented.

### TECHNICAL FIELD

The invention relates to radio-frequency identification (RFID) technology, particularly to a device and a method for detecting a blockage position in a pipeline by RFID technology.

### RELATED ART

Radio-frequency identification (RFID) is a wireless communication technology and uses electromagnetic fields to automatically identify and track tags attached to objects. There is no mechanic or optical contact between the identification system and the objects. The RFID system is composed of an RFID reader and an RFID tag. An RFID tag is used for storing data of an object and attached on the object for tracking and management of inventory, assets, personnel, etc. When triggered by an electromagnetic interrogation pulse from a nearby RFID reader device, the tag transmits digital data, usually an identifying inventory number, back to the reader through an echo signal. Data transfer can be implemented through radio waves between the reader and the tag.

An RFID tag includes an antenna and an RFID chip. The antenna receives a radio-frequency signal from a reader and sends an echo signal back to the reader. The RFID chip may be an IC or a programmed or programmable data processor for storing and processing data and modulating or demodulating radio-frequency signals. Passive tags are powered by energy from the RFID reader's interrogating radio waves.

RFID tags are used in many industries. For example, an RFID tag attached to an automobile during production can be used to track its progress through the assembly line; RFID-tagged pharmaceuticals can be tracked through warehouses; and implanting RFID microchips in livestock and pets enables positive identification of animals. A known device for detecting a blockage position in a pipeline adopts a specific camera to enter a pipeline for detection. For those pipelines without maintenance/detection openings, a destructive opening must be made on the pipeline. Thus, such a detecting device is inconvenient to be applied in completely closed pipelines. Other non-destructive detection technologies are used in detection of pipeline defects, such as ground penetrating radar technology, electromagnetic wave detection technology and magnetic detection technology, but these non-destructive approaches are very expensive and need complicated data processing to judge a pipeline defect. As a result, a new non-destructive detecting solution is required.

### SUMMARY OF THE INVENTION

An object of the invention is to provide a device and a method for detecting a blockage position in a pipeline, which is contactless and non-destructive.

To accomplish the above object, the invention provides a method for detecting a blockage position in a pipeline, which includes the steps of:

a) disposing a radio-frequency identification (RFID) tag in one of the pipes;

b) taking a normal power as a transmitting power;

c) transmitting a first frequency with the transmitting power and then reading a first echo signal sent by the RFID tag;

d) transmitting a second frequency with the transmitting power and then reading a second echo signal sent by the RFID tag, wherein the second frequency is higher than the first frequency; and

e) comparing the first echo signal and the second echo signal to generate a signal standing for whether a position of the pipe at which the RFID tag is located is blocked.

Preferably, the RFID tag is attached on an outside of the pipe or embedded in a tube wall of the pipe.

Preferably, when both the first and second echo signals cannot be read, the transmitting power is increased to repeat a step of reading the first and second echo signals until either of the first and second echo signals can be read.

Preferably, when both the first and second echo signals can be read, the transmitting power is decreased to repeat a step of reading the first and second echo signals until either of the first and second echo signals can be read.

Preferably, when the first echo signal is successfully read but the second echo signal cannot be read, this means a position of the pipe at which the RFID tag is located is blocked, on the contrary, the position of the pipe at which the RFID tag is located is not blocked.

Preferably, when the first echo signal is successfully read but the second echo signal cannot be read, this means a position of the pipe at which the RFID tag is located is blocked, on the contrary, the position of the pipe at which the RFID tag is located is not blocked.

Preferably, when the RFID reader cannot read both the first and second echo signals, the transmitting power is increased to repeat a step of reading the first and second echo signals until both of the first and second echo signals can be read, when both of the first and second echo signals can be read, signal strengths of the first and second echo signals are compared, when the first echo signal is greater than the second echo signal in signal strength, a position of the pipe at which the RFID tag is located is not blocked, on the contrary, the position of the pipe at which the RFID tag is located is blocked.

The invention also provides a device for implementing the above method, which includes a radio-frequency identification (RFID) tag; and an RFID reader. The RFID reader includes a control module, a microprocessor, a radio-frequency (RF) transceiver module and a modem module. The RF transceiver module is connected with the microprocessor through the modem module. The RFID reader transmits an RF signal and receives an echo signal from the RFID tag through the RF transceiver module. The control module is connected to the microprocessor.

Preferably, the control module comprises control software and/or control hardware.

Preferably, the device further comprises a display which is electrically connected to the control module for showing signals of whether a position of the pipe at which the RFID tag is located is blocked or not.

Preferably, the device further comprising a distance measurement module for measuring a distance between the RFID reader and the RFID tag.

Preferably, the device further comprising a support fixed on the RFID reader, wherein an end of the support leans against the pipe for keeping a fixed distance between the RFID reader and the RFID tag.

To accomplish the above object, the invention provides another method for detecting a blockage position in a pipeline, which includes the steps of:

a) disposing an RFID tag in the pipe;

b) taking a normal power as a transmitting power;

c) transmitting a first frequency with the transmitting power at a fixed distance from the RFID tag and then reading a first echo signal sent by the RFID tag;

d) increasing the transmitting power and then repeating step c) when the first echo signal cannot be read;

e) calculating a power difference between the transmitting power and the normal power when the first echo signal is successfully read;

f) generating a signal standing for a position of the pipe at which the RFID tag is located is not blocked when the transmitting power is equal to the normal power; and

g) generating a signal standing for a position of the pipe at which the RFID tag is located is blocked when the power difference is greater than a threshold, and the pipe is not blocked when the power difference is not greater than the threshold.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 shows waveforms of two frequencies for reading the RFID tag and an offset relationship thereof in the first preferred solution of the invention;

FIG. 2 is a structural schematic view of the RFID tag of an exemplary embodiment of the method of the invention;

FIG. 3 is a modular block diagram of an exemplary embodiment of the detecting device of the invention;

FIG. 4 is a cross-sectional view of the RFID tag disposed in a pipe of an exemplary embodiment of the method of the invention;

FIG. 5 is a cross-sectional view of the RFID tag disposed in a pipe of another exemplary embodiment of the method of the invention;

FIG. 6 is a flowchart of an exemplary embodiment of the method of the invention;

FIG. 7 is a flowchart of another exemplary embodiment of the method of the invention;

FIG. 8 is an exemplary flowchart of the second preferred embodiment of the method of the invention, which uses a single frequency to detect a blockage position in a pipeline;

FIG. 9 is a modular block diagram of another exemplary embodiment of the detecting device of the invention;

FIG. 10 is a structural schematic view of another exemplary embodiment of the detecting device shown in FIG. 9; and

FIG. 11 is a schematic view showing multiple RFID tags disposed at different positions of a pipe for finding a blockage.

### DETAILED DESCRIPTION OF THE INVENTION

As used herein, words such as “inner” and “outer,” “interior” and “exterior,” “upper” and “lower,” “outside” and “inside,” “top” and “bottom,” “left” and “right,” “inwardly” and “outwardly” and words of similar import are intended to assist in understanding preferred embodiments of the invention with reference to the accompanying drawing Figures and with respect to the orientation of the sealing assemblies as shown in the Figures, and are not intended to be limiting to the scope of the invention or to limit the invention scope to the preferred embodiments shown in the Figures.

In an RFID (radio-frequency identification) system, performance of RFID tags tends to be affected by environmental media. When an RFID tag is attached on an insulative medium such as plastic or glass, inductance of an antenna will be affected and a quality factor of resonant frequency will be reduced. In other words, when an antenna of an RFID tag is broken or the permittivity (dielectric constant) of the attached material varies, the best reading frequency of an RFID reader will vary. On the other hand, a blockage in a pipe also changes the permittivity and further results in the best reading frequency deviating from a normal frequency and change of strength of an echo signal. The normal frequency is the best reading frequency under predetermined normal conditions. Under the normal frequency, an RFID tag will perform the best performance (the farthest reading distance and the best receiving sensitivity).

Basically, the method for detecting a blockage position in a pipeline of the invention utilizes the abovementioned physical properties of RFID tags in RFID technology. An RFID tag is disposed in a pipe of a pipeline first, the RFID tag is read with a predetermined single or double frequencies, and finally whether the position of the pipe at which the RFID tag is located is blocked or not can be judged by the difference between the echo signals sent from the RFID tag. Thus, a contactless and non-destructive approach of detecting a blockage in a pipeline is implemented.

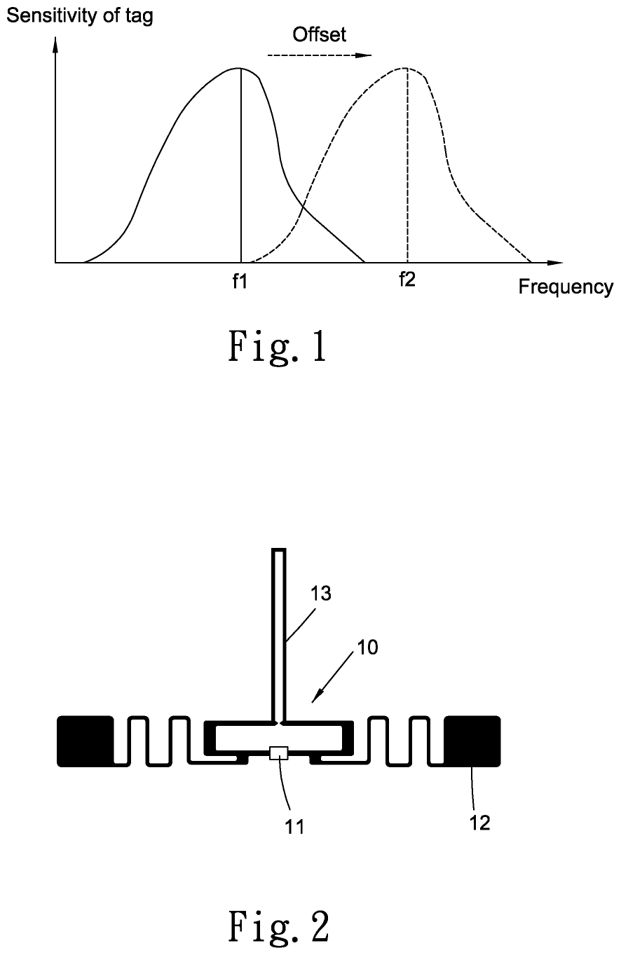

Please refer to FIG. 1, which shows the first embodiment of the method of the invention. In FIG. 1, two frequencies, namely, a first frequency f1 and a second frequency f2, which are used to read an RFID tag are depicted. The first frequency f1 is the best reading frequency and the second frequency f2 is the best reading frequency after a blockage in a pipe has changed the permittivity of an antenna of an RFID tag. Please refer to FIG. 2. An RFID tag 10 includes an RFID chip 11 and an antenna 12 electrically connected to the RFID chip 11. Preferably, the antenna 12 includes a sensing ring 13 directly connected to the antenna 12. The sensing ring 13 performs different impedance characteristics at different bands of radio-frequency so as to affect the best reading frequency of the antenna 12. The best reading frequency is not the only one working frequency of the RFID tag 10 but the antenna 12 performs the best performance (the farthest reading distance and the best receiving sensitivity) at the best reading frequency. When the sensing ring 13 is broken or the permittivity of the attached material varies, the best reading frequency will change. As shown in FIG. 1, the first frequency f1 is normally the best reading frequency of the RFID tag 10. When the sensing ring 13 is broken or the permittivity of the attached material varies, the best reading frequency of the RFID tag 10 will deviate to the second frequency f2. The second frequency f2 is higher than the first frequency f1.

The method of the invention is available in non-metallic tubes such as PVC tubes.

### [The First Preferred Solution]

The first preferred solution of the method of the invention includes the steps of:

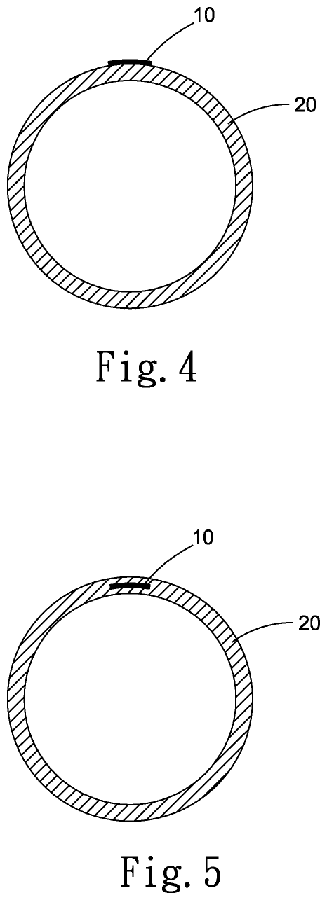

A1) disposing an RFID tag 10 in one of non-metallic pipes 20 constituting a pipeline, wherein the RFID tag 10 may be attached on the outside of the pipe 20 as shown in FIG. 4 or embedded in a tube wall of the pipe 20 as shown in FIG. 5;

A2) taking a normal power as a transmitting power (an initial transmitting power), wherein the normal power means the lowest signal transmitting power which can normally trigger the RFID tag 10;

A3) transmitting a first frequency f1 with the transmitting power and then reading a first echo signal sent by the RFID tag 10, wherein the first frequency f1 is preferably the normal frequency;

A4) transmitting a second frequency f2 with the transmitting power and then reading a second echo signal sent by the RFID tag 10, wherein the second frequency f2 is higher than the first frequency f1; and

A5) comparing the first echo signal and the second echo signal to generate a signal standing for whether a position of the pipe at which the RFID tag 10 is located is blocked.

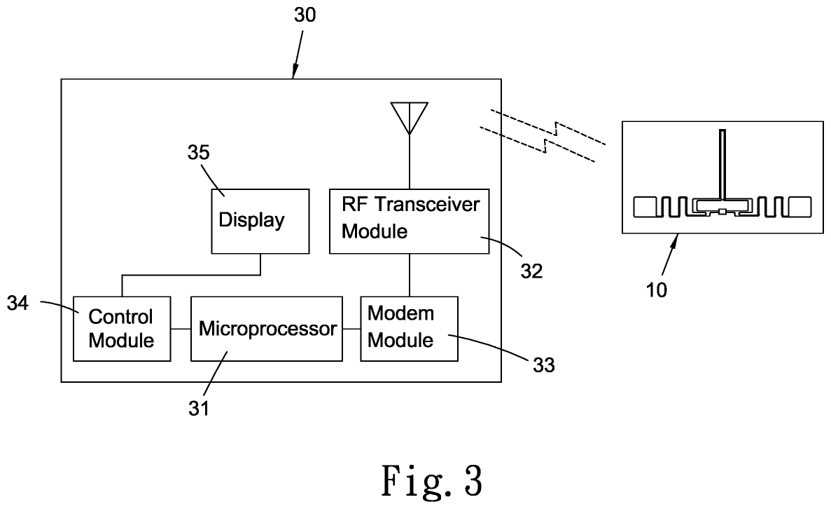

Please refer to FIG. 3, which is a modular block diagram of an exemplary embodiment of the detecting device of the invention. The detecting device may be used to implement the above method. The detecting device includes the RFID tag 10 and an RFID reader 30. The RFID 10 may be attached on a pipe 20 or embedded in a tube wall of a pipe 20. The RFID reader 30 includes a control module 34 for controlling the RFID reader 30 to implement the steps of the above method of the invention.

The RFID reader 30 includes a control module 34, a microprocessor 31, an RF transceiver module 32 and a modem module 33. The RF transceiver module 32 is connected with the microprocessor 31 through the modem module 33. The RFID reader 30 transmits an RF signal and receives an echo signal from the RFID tag 10 through the RF transceiver module 32. The control module may be implemented by control software, control hardware or a combination thereof. The control module 34 depicted in FIG. 3 is control hardware, for example, a logic circuit or a programmable logic controller (PLC). The control module 34 implemented by control software may be control software stored in the microprocessor 31.

Preferably, the RFID reader 30 further includes a display 35 which is electrically connected to the control module 34 for showing signals of whether the position of a pipe 20 at which the RFID tag 10 is located is blocked or not. The display 35 may be an LCD or a numeral display.

The method for detecting a blockage position in a pipeline of the invention and the control module 34 performing the steps of the method will be described by the following embodiments.

### Embodiment 1

The RFID reader 30 works with the first frequency f1 and the second frequency f2 and in a manner of automatic power adjustment to detect whether a position of the pipe 20 at which the RFID tag 10 is located is blocked or not according to the difference between a first echo signal and a second echo signal sent from the RFID tag 10. For example, in an initial status, the transmitting power of sending RF signals with the first frequency f1 and the second frequency f2 is the normal power, if the RFID reader 30 cannot read both the first and second echo signals from the RFID tag 10, the RFID reader 30 progressively increases the transmitting power to repeat the step of reading the first and second echo signals until either of the first and second echo signals can be read.

On the contrary, if the RFID reader 30 can read both the first and second echo signals, the RFID reader 30 progressively decreases the transmitting power to repeat the step of reading the first and second echo signals until either of the first and second echo signals can be read. When the first echo signal is successfully read but the second echo signal cannot be read, this means the position of the pipe 20 at which the RFID tag 10 is located is blocked. On the contrary, the position of the pipe 20 at which the RFID tag 10 is located is not blocked.

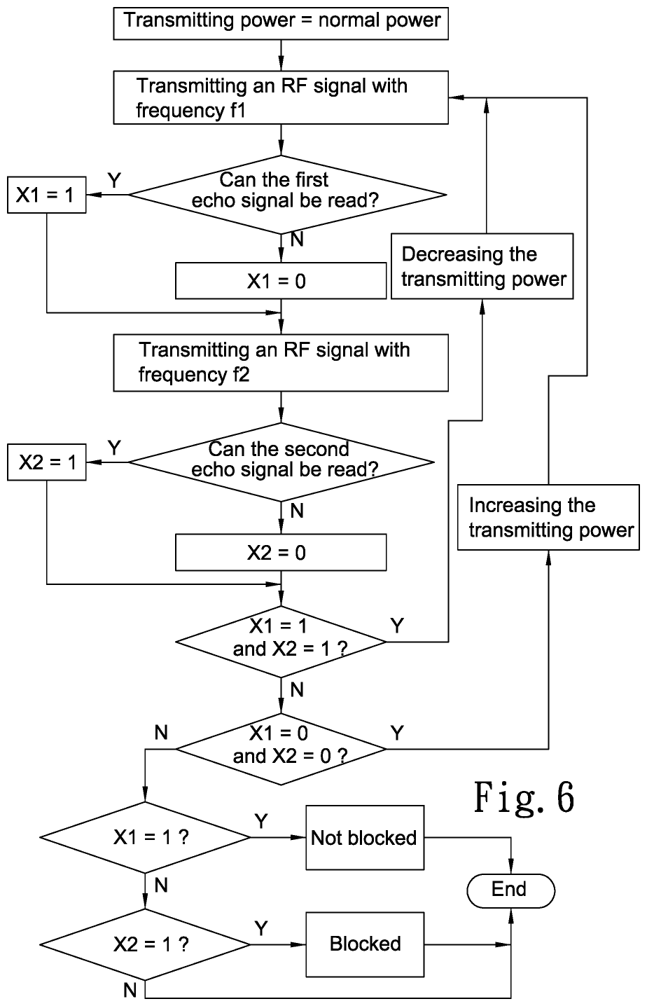

Please refer to FIG. 6, which is a flowchart of the control module 34 implementing the above steps. In FIG. 6, parameter X1=1 means the RFID reader 30 can read the first echo signal, parameter X1=0 means the RFID reader 30 cannot read the first echo signal, parameter X2=1 means the RFID reader 30 can read the second echo signal, parameter X2=0 means the RFID reader 30 cannot read the second echo signal.

### Embodiment 2

The RFID reader 30 works with the first frequency f1 and the second frequency f2 and in a manner of constant transmitting power or automatic power adjustment. If the RFID reader 30 cannot read both the first and second echo signals, the RFID reader 30 increases the transmitting power to repeat the step of reading the first and second echo signals until both of the first and second echo signals can be read. Then, the RFID reader 30 compares strengths of wireless signals of the first and second echo signals (Received Signal Strength Indicator, RSSI). If the first echo signal is greater than the second echo signal in signal strength, this means the position of the pipe 20 at which the RFID tag 10 is located is not blocked. On the contrary, if the second echo signal is greater than the first echo signal in signal strength, this means the position of the pipe 20 at which the RFID tag 10 is located is blocked.

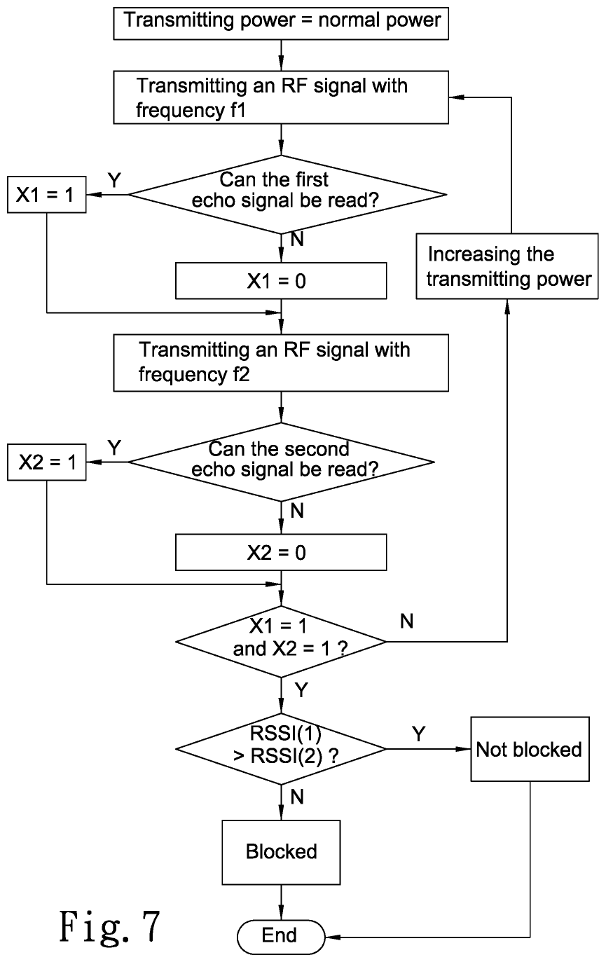

Please refer to FIG. 7, which is a flowchart of the control module 34 implementing the above steps. In FIG. 7, parameter X1=1 means the RFID reader 30 can read the first echo signal, parameter X1=0 means the RFID reader 30 cannot read the first echo signal, parameter X2=1 means the RFID reader 30 can read the second echo signal, parameter X2=0 means the RFID reader 30 cannot read the second echo signal.

### [The Second Preferred Solution]

The second preferred solution of the method of the invention includes the steps of:

B1) disposing an RFID tag 10 in a pipe 20 constituting a pipeline;

B2) taking a normal power as a transmitting power;

B3) transmitting a first frequency f1 with the transmitting power at a fixed distance from the RFID tag 10 and then reading a first echo signal sent by the RFID tag 10, wherein the first frequency f1 is preferably the normal frequency of the RFID tag 10;

B4) increasing the transmitting power and then repeating step B3) when the first echo signal cannot be read;

B5) calculating a power difference between the transmitting power and the normal power when the first echo signal is successfully read;

B6) generating a signal standing for a position of the pipe at which the RFID tag 10 is located is not blocked when the transmitting power is equal to the normal power (the power difference=0); and

B7) generating a signal standing for a position of the pipe at which the RFID tag 10 is located is blocked when the power difference is greater than a threshold, and the pipe is not blocked when the power difference is not greater than the threshold.

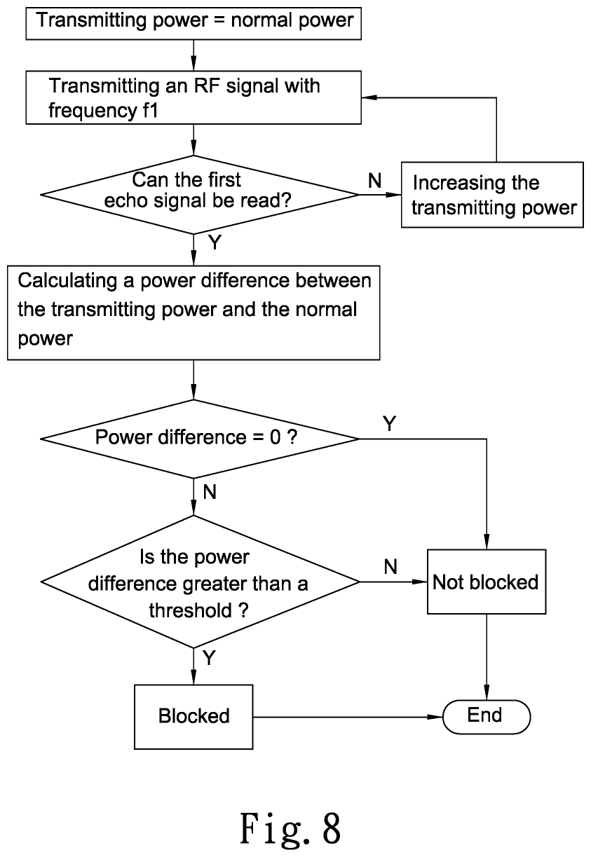

The second preferred solution may also be implemented by the device shown in FIG. 3. The above steps are shown in FIG. 8.

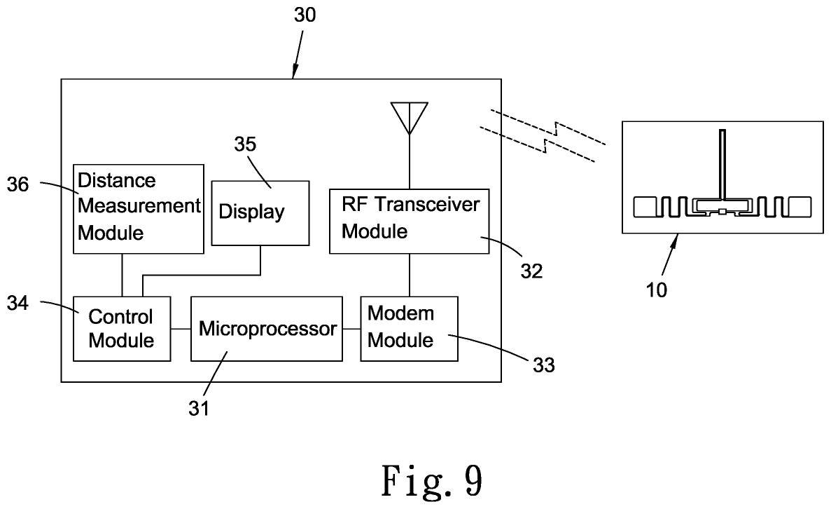

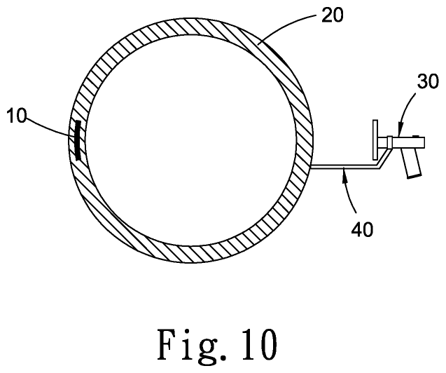

Please refer to FIG. 9, which is a modular block diagram of another exemplary embodiment of the detecting device of the second preferred solution of the invention. The RFID reader 30 further includes a distance measurement module 36 for measuring a distance between the RFID reader 30 and the RFID tag 10 and showing the measured distance on the display 35 of the RFID reader 30. Preferably, the RFID reader 30 is a movable RFID reader. A user can adjust the position of the RFID reader 30 according to the distance measured by the distance measurement module 36 so as to keep the fixed distance between the RFID reader 30 and the RFID tag 10.

Preferably, the detecting device further includes a support 40 fixed on the RFID reader 30. An end of the support 40 leans against the pipe 20 for keeping the fixed distance between the RFID reader 30 and the RFID tag 10.

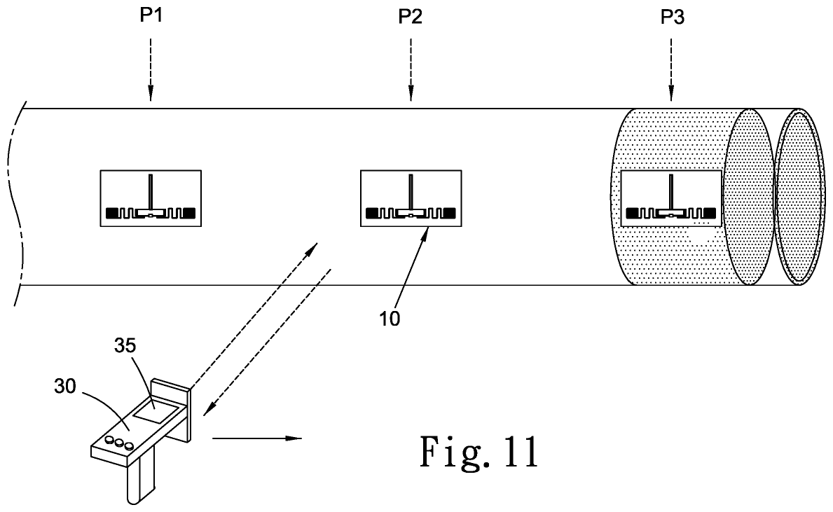

Preferably, the method of the invention further includes disposing multiple RFID tags 10 at different positions of the pipe 20 as shown in FIG. 11. The RFID reader 30 reads the RFID tags 10 one by one to find out the position of blockage. For example, the RFID reader 30 is moved along the pipe 20 toward a specific direction as shown in FIG. 11. Positions P1 and P2 at which the RFID tags 10 are located are not blocked, and position P3 is blocked. When the RFID reader 30 is moved to position P3, the blockage in the pipe 20 can be detected by the echo signal sent from the RFID tag 10.

What is claimed is:

1. A method for detecting a blockage position in a pipeline composed of non-metallic pipes, comprising:
a) disposing a radio-frequency identification (RFID) tag in one of the pipes;
b) taking a normal power as a transmitting power;
c) transmitting a first frequency with the transmitting power and then reading a first echo signal sent by the RFID tag;
d) transmitting a second frequency with the transmitting power and then reading a second echo signal sent by the RFID tag, wherein the second frequency is higher than the first frequency; and
e) comparing the first echo signal and the second echo signal to generate a signal standing for whether a position of the pipe at which the RFID tag is located is blocked.

2. The method of claim 1, wherein the RFID tag is attached on an outside of the pipe or embedded in a tube wall of the pipe.

3. The method of claim 1, wherein when both the first and second echo signals cannot be read, the transmitting power is increased to repeat a step of reading the first and second echo signals until either of the first and second echo signals can be read.

4. The method of claim 1, wherein when both the first and second echo signals can be read, the transmitting power is decreased to repeat a step of reading the first and second echo signals until either of the first and second echo signals can be read.

5. The method of claim 3, wherein when the first echo signal is successfully read but the second echo signal cannot be read, this means a position of the pipe at which the RFID tag is located is blocked, on the contrary, the position of the pipe at which the RFID tag is located is not blocked.

6. The method of claim 4, wherein when the first echo signal is successfully read but the second echo signal cannot be read, this means a position of the pipe at which the RFID tag is located is blocked, on the contrary, the position of the pipe at which the RFID tag is located is not blocked.

7. The method of claim 1, wherein when the RFID reader cannot read both the first and second echo signals, the transmitting power is increased to repeat a step of reading the first and second echo signals until both of the first and second echo signals can be read, when both of the first and second echo signals can be read, signal strengths of the first and second echo signals are compared, when the first echo signal is greater than the second echo signal in signal strength, a position of the pipe at which the RFID tag is located is not blocked, on the contrary, the position of the pipe at which the RFID tag is located is blocked.

8. A device for detecting a blockage position in a pipeline composed of non-metallic pipes, comprising:
a radio-frequency identification (RFID) tag; and
an RFID reader, comprising a control module, a microprocessor, a radio-frequency (RF) transceiver module and a modem module, wherein the RF transceiver module is connected with the microprocessor through the modem module, the RFID reader transmits an RF signal and receives an echo signal from the RFID tag through the RF transceiver module, and the control module is connected to the microprocessor.

9. The device of claim 8, wherein the control module comprises control software and/or control hardware.

10. The device of claim 8, further comprising a display which is electrically connected to the control module for showing signals of whether a position of the pipe at which the RFID tag is located is blocked or not.

11. The device of claim 8, further comprising a distance measurement module for measuring a distance between the RFID reader and the RFID tag.

12. The device of claim 8, further comprising a support fixed on the RFID reader, wherein an end of the support leans against the pipe for keeping a fixed distance between the RFID reader and the RFID tag.

13. A method for detecting a blockage position in a pipeline composed of non-metallic pipes, comprising:
a) disposing an RFID tag in the pipe;
b) taking a normal power as a transmitting power;
c) transmitting a first frequency with the transmitting power at a fixed distance from the RFID tag and then reading a first echo signal sent by the RFID tag;
d) increasing the transmitting power and then repeating step c) when the first echo signal cannot be read;
e) calculating a power difference between the transmitting power and the normal power when the first echo signal is successfully read;
f) generating a signal standing for a position of the pipe at which the RFID tag is located is not blocked when the transmitting power is equal to the normal power; and
g) generating a signal standing for a position of the pipe at which the RFID tag is located is blocked when the power difference is greater than a threshold, and the pipe is not blocked when the power difference is not greater than the threshold.
